(19) United States
(12) Patent Application Publication
(10) Pub. No.: US 2007/0084442 A1
(43) Pub. Date: Apr. 19, 2007

(54) Engine combustion state determining apparatus and method

(75) Inventors: Yousuke Nakagawa, Kariya-city (JP); Masaomi Inoue, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/582,375

(22) Filed: Oct. 18, 2006

(30) Foreign Application Priority Data
Oct. 18, 2005 (JP) 2005-302433

(51) Int. Cl. F02P 5/00; F02M 7/00; G01M 19/00

(52) U.S. Cl. 123/406.27; 123/435; 73/118.1

(57) ABSTRACT

An ECU detects heat generation center of gross heat value. A combustion state of an engine is determined based on the heat generation center. When a deviation between the average heat generation center and the subject heat generation center exceeds a predetermined value, the ECU determines that the engine combustion state is deteriorated. With respect to a cylinder in which the combustion state is deteriorated, fuel injection amount is increased. With respect to a cylinder in which the combustion state is not deteriorated, the fuel injection amount is decreased in order to perform lean-limit control.

### CROSS REFERENCE TO RELATED APPLICATIONS

This application is based on Japanese Patent Applications No. 2005-302433 filed on Oct. 18, 2005, the disclosure of which is incorporated herein by reference.

### FIELD OF THE INVENTION

The present invention relates to an engine combustion state determining apparatus and method. This apparatus and method determine a combustion state of an internal combustion engine.

### BACKGROUND OF THE INVENTION

JP-3-246326A describes that an abnormal combustion is detected based on a heat generation amount at an in-cylinder pressure peak position. The heat generation amount is calculated based on a volume of a combustion chamber and the in-cylinder pressure at the in-cylinder pressure peak position.

The heat generation amount varies according to a driving condition, such as fuel injection amount and the like. In a system in which the abnormal combustion is detected based on the heat generation amount, a threshold should be established with respect to every driving condition in order to detect a partial misfire. Thus, additional steps are required to adjust the threshold every driving condition, which increases man-hour.

Besides, the in-cylinder pressure peak position is retarded or advanced due to deterioration degree of combustion. Thus, it may be hard to distinguish the normal combustion from the abnormal combustion.

Japanese paten No. 2609892 describes that a heat generation center of gross heating amount is detected and ignition timing is controlled such that the heat generation center is positioned at a predetermined crank angle. However, the deterioration of combustion is not detected.

### SUMMARY OF THE INVENTION

The present invention is made in view of the foregoing matter and it is an object of the present invention to provide an engine combustion state determining apparatus and method that precisely determine combustion state without increasing additional steps.

According to a state determining apparatus of the present invention, the apparatus includes a center detecting means for detecting a heat generation center of gross heating amount in a combustion period from a start of combustion to a termination of combustion; and a state determining means for determining a combustion state of the internal combustion engine based on the heat generation center detected by the center detecting means.

According to a state determining method, detecting a heat generation center of gross heating amount in a combustion period from a start of combustion to a termination of combustion; and then determining a combustion state of the internal combustion engine based on the heat generation center.

### BRIEF DESCRIPTION OF THE DRAWINGS

The above and other objects, features, and advantages of the present invention will become more apparent from the following detailed description made with reference to the accompanying drawings, in which like parts are designated by like reference number and in which:

FIG. 1 is a schematic view of an engine control system according to a first embodiment;

FIG. 2 is a flow chart showing a combustion state determining routine according to the first embodiment;

FIG. 3 is a time chart showing a relationship between in-cylinder pressure and heat generation value at a time of normal combustion, and a relationship between in-cylinder pressure and heat generation value at a time of abnormal combustion;

FIG. 4 is a time chart showing a heat generation center at a time of normal combustion and a heat generation center at a time of abnormal combustion;

FIG. 5 is a chart showing a distribution of experimental data relating to heat generation centers at the time of normal combustion and abnormal combustion;

FIG. 6 is a chart showing a relationship between the heat generation center and an engine speed;

FIG. 7 is a flow chart showing a combustion state determining routine according to a second embodiment; and

FIG. 8 is a flow chart showing a combustion state determining routine according to a third embodiment.

### DETAILED DESCRIPTION OF THE PREFERRED EMBODIMENTS

Embodiments of the present invention will be described hereinafter with reference to the drawings.

### First Embodiment

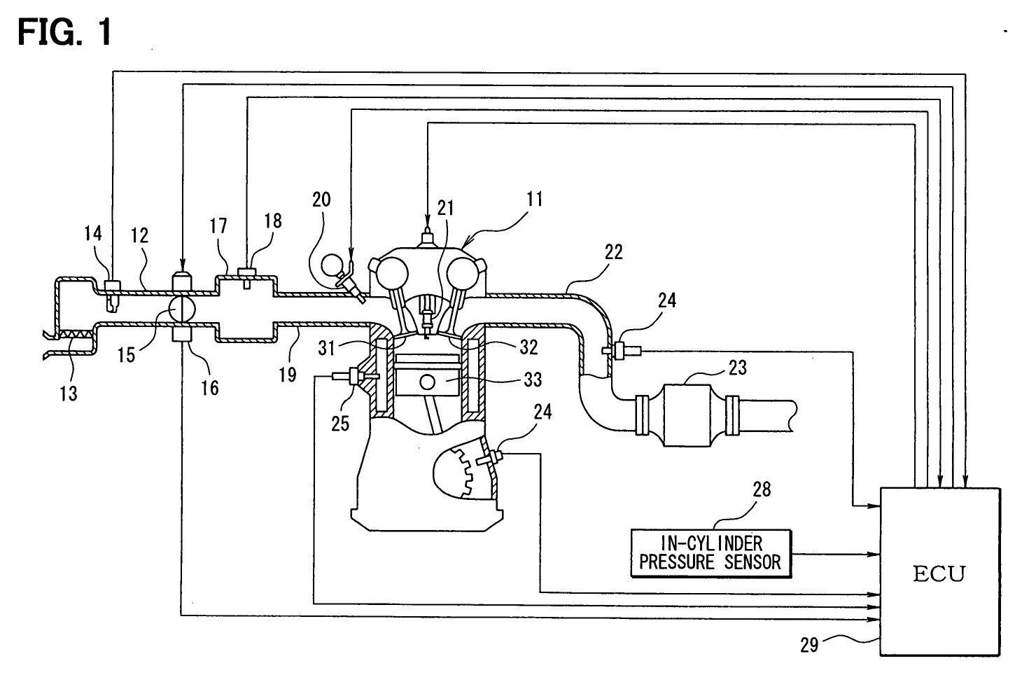

Referring to FIGS. 1 to 6, a first embodiment is described. FIG. 1 is a schematic view of an engine control system. An internal combustion engine 11 is a lean-burn engine. An air cleaner 13 is arranged upstream of an intake pipe 12 of the internal combustion engine 11. An airflow meter 14 detecting an intake air flowrate is provided downstream of the air cleaner 13. A throttle valve 15 driven by a DC-motor and a throttle position sensor 16 detecting a throttle position are provided downstream of the air flow meter 14.

A surge tank 17 including an intake air pressure sensor 18 is provided down stream of the throttle valve 15. The intake air pressure sensor 18 detects intake air pressure. An intake manifold 19 is connected to the surge tank 17. Fuel injectors 20 are mounted on the intake manifold 19 at a vicinity of an intake air port of each cylinder. A spark plug 21 is respectively provided on each cylinder head of the engine 11. When the spark plug 21 generates spark, the fuel in each cylinder is ignited.

An exhaust pipe 22 of the engine 11 is provided with a three-way catalyst 23 purifying CO, HC, and NOx in the exhaust gas. An exhaust gas sensor 24 (an air-fuel ratio sensor, an oxygen sensor) disposed upstream of the three-way catalyst 23 detects air-fuel ratio or rich/lean of the exhaust gas.

A coolant temperature sensor 25 detecting a coolant temperature and a crank angle senor 26 outputting a pulse signal every predetermined crank angle of a crankshaft of the engine 11 are disposed on a cylinder block of the engine 11. The crank angle and an engine speed are detected based on the output signal of the crank angle sensor 26. An in-cylinder pressure sensor 28 is provided on the cylinder head of the engine 11 for detecting in-cylinder pressure. The in-cylinder pressure sensor 28 can be integrated with the spark plug 21.

The outputs from the above sensors are inputted into an electronic control unit 29, which is referred to an ECU hereinafter. The ECU 29 includes a microcomputer which executes an engine control program stored in a ROM (Read Only Memory) to control a fuel injection amount of a fuel injector 20 based on an engine running condition and an ignition timing of the spark plug 21.

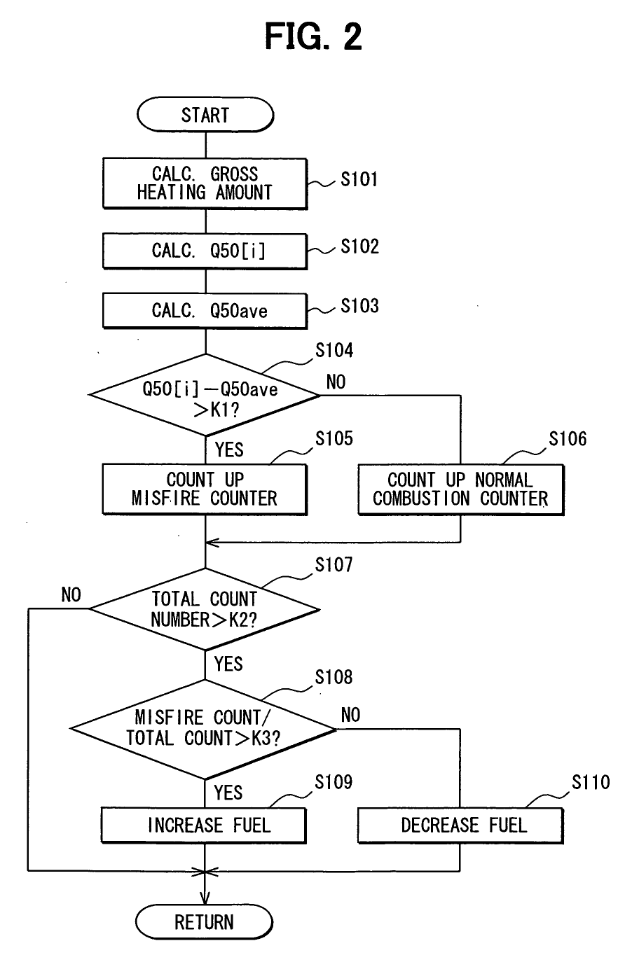

The ECU 29 executes a combustion state determining routine shown in FIG. 2, whereby a heat generation center of gross heating amount from a combustion-start to a combustion-termination is detected. The computer determines a combustion state of the engine based on the heat generation center. A fuel injection quantity is increased with respect to the cylinder in which combustions state is deteriorated. The fuel injection quantity is decreased with respect to the cylinder in which combustion state is not deteriorated. Thereby, air-fuel ratio of air-fuel mixture supplied to each cylinder is brought to approximately lean combustion limit, which is referred to as a lean limit control.

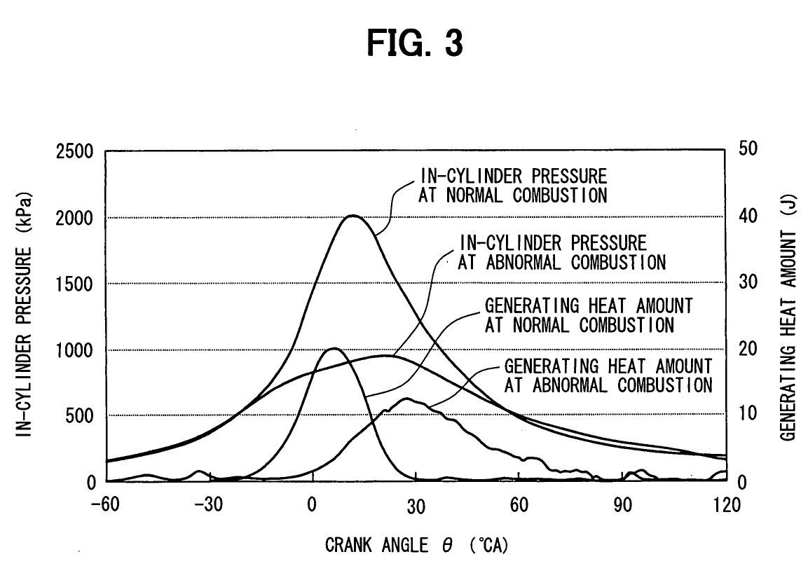

Referring to FIGS. 3 to 6, a method of determining the combustion state will be described hereinafter.

FIG. 3 is a time chart showing a relationship between in-cylinder pressure and the gross heating amount in normal combustion and abnormal combustion.

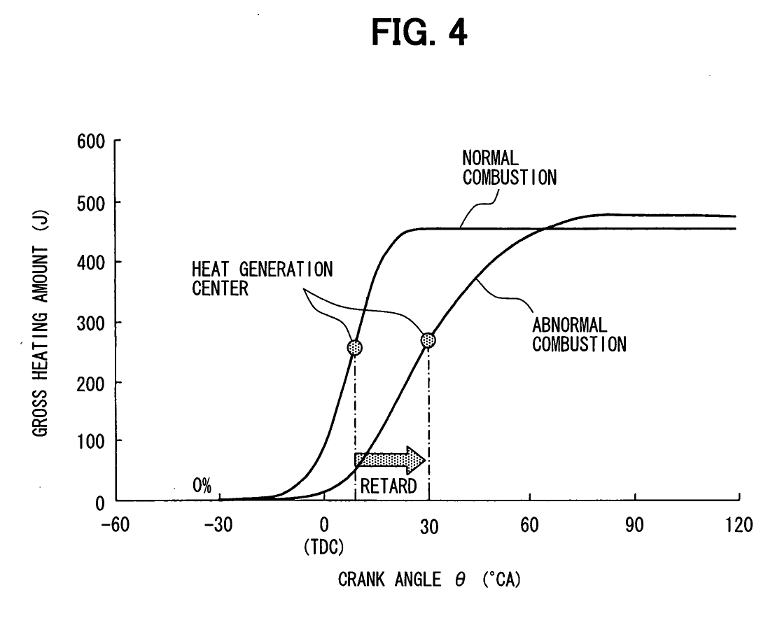

FIG. 4 is a time chart showing a relationship between the heat generation center of gross heating amount of normal combustion and the heat generation center of gross heating amount of abnormal combustion.

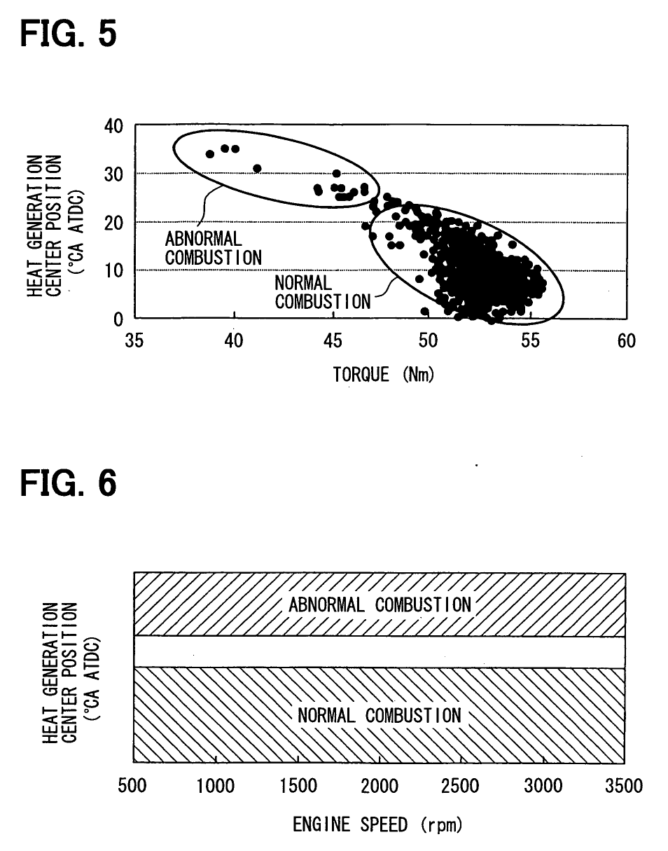

FIG. 5 is a chart showing a distribution of experimental data with respect to the heat generation center of gross heating amount.

FIG. 6 is a chart showing a relationship between the heat generation center and the engine speed.

As shown in FIG. 3, the in-cylinder pressure of abnormal combustion is lower than that of normal combustion, and a peak position of the in-cylinder pressure of abnormal combustion is retarded relative to a peak position of normal combustion. In a case of the normal combustion, a peak position of the in-cylinder pressure is retarded relative to a peak position of the gross heating amount. In a case of the abnormal combustion, the peak position of the gross heating amount is retarded relative to the peak position of the in-cylinder pressure.

Generally, generating heat amount (HA) at a crank angle θ is expressed by a following equation.
HA={dp(θ)·V(θ)+κ·P(θ)·dV(θ)}/(κ−1)
κ: ratio of specific heat
P(θ): in-cylinder pressure at crank angle θ
dP(θ): variation in in-cylinder pressure at crank angle θ
V(θ): volume of combustion chamber at crank angle θ
dV(θ): variation in volume of combustion chamber at crank angle θ

The gross heating amount (GHA) is expressed by a following equation.
GHA=∫(HA)dθ

In the first embodiment, 50% position of the gross heating amount is defined as the heat generation center. That is, the heat generation center is a crank angle in which total generating heat amount from the combustion-start reaches 50% of gross heating amount. The heat generation center can be 45% position or 55% position.

As shown in FIGS. 4 and 5, since the heat generation center is retarded when the combustion state is deteriorated, the heat generation center of gross heating amount can be a parameter to evaluate the combustion state. As shown in FIG. 6, the heat generation center is substantially constant without respect to the engine speed. Thus, the combustion state is correctly determined based on the heat generation center.

The ECU 29 conducts a routine shown in FIG. 2 to perform the determination of the combustion state. This routine is executed every when the power stroke of each cylinder is terminated. In step 101, the gross heating amount (GHA) is calculated. In step 102, the heat generation center Q50[i] is calculated. In step 103, an average value Q50ave of the heat generation center in a predetermined past period is calculated. This average value Q50ave can be obtained by integrating n-piece of data Q50[i−1], Q50[i−2], . . . Q50[i−n] and divided by n, which is the number of data. Alternatively, the average value Q50ave can be obtained by smoothing the heat generation center of gross heating amount Q50. The average value Q50ave is used as data indicative of the heat generation center of the normal combustion.

In step 104, a deviation between the heat generation center Q50[i] and the average value Q50ave is compared with a predetermined value K1. When the deviation is larger than the predetermined value K1, the computer determines that a misfire (abnormal combustion) has occurred. The procedure proceeds to step 105 to count up a misfire counter. When the deviation is equal to or smaller than the predetermined value K1, the computer determines that the normal combustion is maintained. The procedure proceeds to step 106 to count up the normal combustion counter.

Then, the procedure proceeds to step 107 in which it is determined whether a total count number of the misfire counter and the normal combustion counter exceeds a predetermined value K2. When the answer is No in step 107, the procedure ends. When the answer is Yes, the procedure proceeds to step 108.

In step 108, a ratio between the misfire count number and the total count number is calculated as a misfire frequency. This misfire frequency is compared with a predetermined value K3. When the misfire frequency exceeds the value K3, the computer determines that the air-fuel ratio exceeds the lean-burn limit and the procedure proceeds to step 109 in which the fuel injection amount is correctly increased and at least one of ignition timing, valve timing and exhaust gas recirculation amount is corrected to improve the combustion state.

When the misfire frequency does not exceeds the value K3, the computer determines that the air-fuel ratio does not exceed the lean-burn limit and the procedure proceeds to step 110 in which the fuel injection amount is correctly decreased and at least one of ignition timing, valve timing and exhaust gas recirculation amount is corrected to be an appropriate value around the lean-burn limit.

According to the first embodiment, the fuel injection amount is corrected based on the misfire frequency, so that the fuel injection amount is controlled to be close to the lean-burn limit to improve fuel economy. Furthermore, combustion stability at a vicinity of lean-burn limit can be improved.

At a transitive driving condition in which the engine speed is increasing, the ignition timing is slightly retarded. The heat generation center of gross heating amount is slightly retarded, so that the normal combustion may be hardly distinguished from the abnormal combustion. According to the first embodiment, the computer determines whether the abnormal combustion has occurred by comparing the average heat generation center with the subject heat generation center, so that the misfire can be detected based on the average value which is detected under the condition in which the ignition timing is retarded. Thus, even in the transitive driving condition, the abnormal combustion, such as misfire, can be correctly detected.

The average value of the heat generation center can be stored in ROM as a constant number. The computer determines whether the misfire has occurred by comparing the stored value with the subject heat generation center. Alternatively, the computer can determines whether the misfire has occurred according to whether the subject heat generation center exceeds a predetermined combustion threshold (for example, ATDC 25° CA).

### Second Embodiment

According to a second embodiment, the combustion state is determined based on a heat generation peak position in which the heat generation is maximum in the combustion period from combustion-start to combustion-terminate.

As shown in FIG. 3, since the heat generation peak position is retarded when the combustion state is deteriorated, the heat generation peak position can be a parameter to evaluate the combustion state. This heat generation peak position is substantially constant without respect to the engine speed, so that the combustion state is correctly determined.

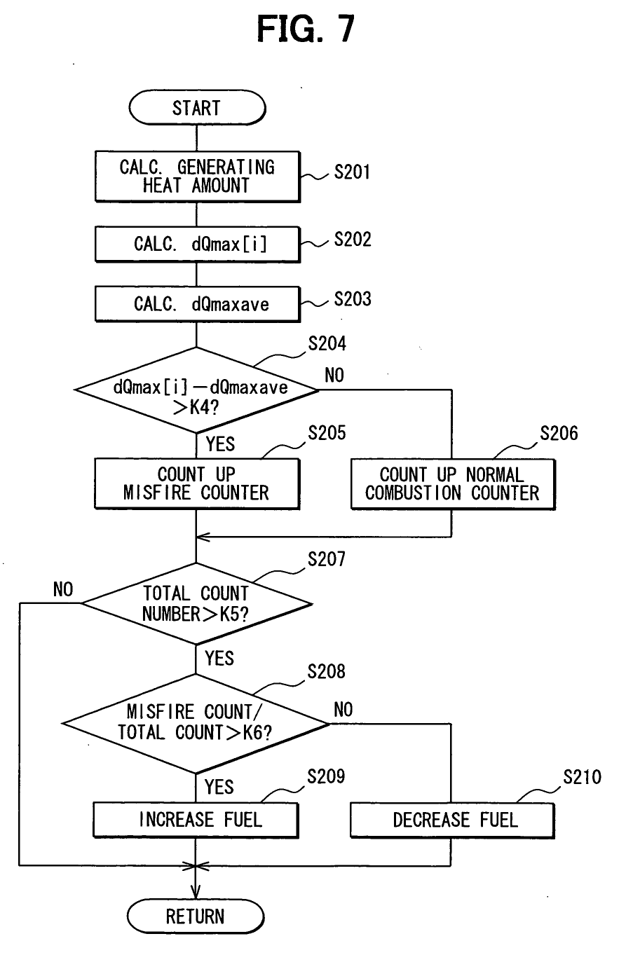

The ECU 29 executes a routine shown in FIG. 7. In step 201, the generating heat amount (HA) at a crank angle θ is calculated based on the following equation.
HA={dp(θ)·V(θ)+κ·P(θ)·dV(θ)}/(κ−1)
κ: ratio of specific heat
P(θ): in-cylinder pressure at crank angle θ
dP(θ): variation in in-cylinder pressure at crank angle θ
V(θ): volume of combustion chamber at crank angle θ
dV(θ): variation in volume of combustion chamber at crank angle θ

In step 202, a heat generation peak position dQmax[i] is calculated every crank angle. In step 203, the average value dQmaxave of the peak position in a past period is calculated. This average value dQmaxave can be obtained by integrating n-piece of data dQmax[i−1], dQmax[i−2], . . . dQmax[i−n] and divided by n, which is the number of data. Alternatively, the average value dQmax can be obtained by smoothing the heat generation peak position dQmax. The average value dQmaxave is used as data indicative of the heat generation peak of the normal combustion.

In step 204, a deviation between the subject heat generation peak position dQmax[i] and the average value dQmaxave is compared with a predetermined value K4. When the deviation is larger than the predetermined value K4, the computer determines that a misfire (abnormal combustion) has occurred. The procedure proceeds to step 205 to count up a misfire counter. When the deviation is equal to or smaller than the predetermined value K4, the computer determines that the normal combustion is maintained. The procedure proceeds to step 205 to count up the normal combustion counter.

Then, the procedure proceeds to step 207 in which it is determined whether a total count number of the misfire counter and the normal combustion counter exceeds a predetermined value K5. When the answer is No in step 207, the procedure ends. When the answer is Yes, the procedure proceeds to step 208.

In step 208, a ratio between the misfire count number and the total count number is calculated as a misfire frequency. This misfire frequency is compared with a predetermined value K6. When the misfire frequency exceeds the value K6, the computer determines that the air-fuel ratio exceeds the lean-burn limit and the procedure proceeds to step 209 in which the fuel injection amount is correctly increased and at least one of ignition timing, valve timing and exhaust gas recirculation amount is corrected to improve the combustion state.

When the misfire frequency does not exceeds the value K6, the computer determines that the air-fuel ratio does not exceed the lean-burn limit and the procedure proceeds to step 210 in which the fuel injection amount is correctly decreased and at least one of ignition timing, valve timing and exhaust gas recirculation amount is corrected to be an appropriate value around the lean-burn limit.

The second embodiment has almost the same advantages as the first embodiment described above.

### Third Embodiment

As shown in FIG. 3, in the case of the normal combustion, the in-cylinder pressure peak position appears at later crank angle than the heat generation peak position. On the other hand, in the case of the abnormal combustion, the heat generation peak position appears at later crank angle than the in-cylinder pressure peak position.

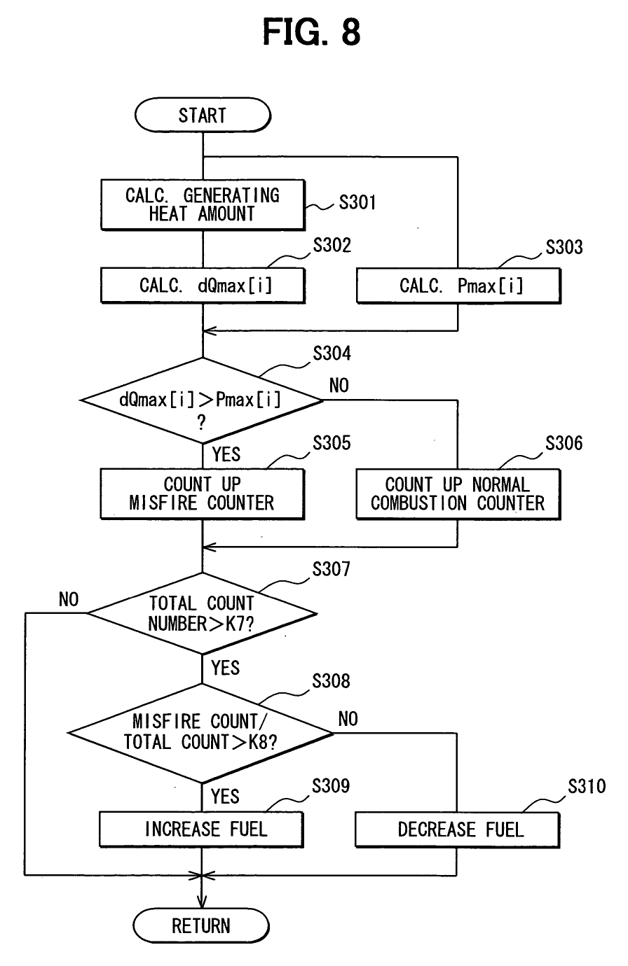

In a third embodiment, the combustion state is determined by comparing the heat generation peak position with the in-cylinder pressure peak position. The ECU 29 executes a routine shown in FIG. 8.

In step 301, the heat generation value at each crank angle θ is calculated. In step 302, the heat generation peak position dQmax[i] is calculated. In step 303, the in-cylinder pressure peak position Pmax[i] is calculated. In step 304, when the heat generation peak position dQmax[i] appears later than the in-cylinder pressure position Pmax[i], the computer determines that the misfire is generated. The procedure proceeds to step 305 in which the misfire counter is counted up. Contrary, when the heat generation peak position dQmax[i] appears earlier than the in-cylinder pressure peak Pmax[i], the computer determines that the normal combustion is maintained. The procedure proceeds to step 305 in which the normal combustion counter is counted up.

Then, the procedure proceeds to step 307 in which it is determined whether a total count number of the misfire counter and the normal combustion counter exceeds a predetermined value K7. When the answer is No in step 307, the procedure ends. When the answer is Yes, the procedure proceeds to step 308.

In step 308, a ratio between the misfire count number and the total count number is calculated as a misfire frequency. This misfire frequency is compared with a predetermined value K8. When the misfire frequency exceeds the value K8, the computer determines that the air-fuel ratio exceeds the lean-burn limit and the procedure proceeds to step 309 in which the fuel injection amount is correctly increased and at least one of ignition timing, valve timing and exhaust gas recirculation amount is corrected to improve the combustion state.

When the misfire frequency does not exceeds the value K8, the computer determines that the air-fuel ratio does not exceed the lean-burn limit and the procedure proceeds to step 310 in which the fuel injection amount is correctly decreased and at least one of ignition timing, valve timing and exhaust gas recirculation amount is corrected to be an appropriate value around the lean-burn limit.

According to the third embodiment, the fuel injection amount is corrected based on the misfire frequency, so that the fuel injection amount is controlled to be close to the lean-burn limit to improve fuel economy. The combustion stability at a vicinity of lean-burn limit can be improved.

Furthermore, since the combustion state is determined based on the heat generation peak position and the in-cylinder pressure peak position, the computer can determines whether the piston movement is caused by combustion or engine brake, so that the combustion state is well determined.

In the third embodiment, the combustion state can be determined based on the heat generation center of gross heating amount and the in-cylinder pressure peak position.

In the above first to third embodiments, the present invention is applied to the lean-burn engine. The present invention can be applied to an intake port injection engine or a direct injection engine.

In the system in which the combustion state is determined based on the in-cylinder pressure peak position, the combustion state can be determined based on an advanced angle of the subject in-cylinder pressure peak position relative to the in-cylinder pressure peak position of the normal combustion. Alternatively, the combustion state can be determined based on a deviation between an average value of the in-cylinder pressure peak position and the subject in-cylinder pressure peak position.

What is claimed is:

1. A combustion state determining apparatus for an internal combustion engine, comprising:
a center detecting means for detecting a heat generation center of gross heating amount in a combustion period from a start of combustion to a termination of combustion; and
a state determining means for determining a combustion state of the internal combustion engine based on the heat generation center detected by the center detecting means.

2. A combustion state determining apparatus according to claim 1, wherein the center detecting means detects 50% position of the gross heating amount as the heat generation center.

3. A combustion state determining apparatus according to claim 1, wherein the state determining means determines the combustion state by comparing a subject heat generation center with an average of the heat generation centers which have detected in a predetermined period.

4. A combustion state determining apparatus according to claim 3, wherein the state determining means determines that the combustion state is deteriorated when a frequency in which a deviation between the subject heat generation center and the average of the heat generation center exceeds a predetermined value is larger than a predetermined threshold.

5. A combustion state determining apparatus according to claim 1, further comprising:
an air-fuel ratio control means for performing a lean-limit control in which an air-fuel ratio of air-fuel mixture to be supplied to the internal combustion engine is brought to a vicinity of a lean-combustion limit,
wherein the air-fuel ratio control means corrects a fuel injection amount to be increased in a case where a deterioration of the combustion state is detected, and corrects the fuel injection amount to be decreased in a case where the deterioration of the combustion state is not detected.

6. A combustion state determining apparatus according to claim 5, wherein the air-fuel ratio control means adjusts at least one of an ignition timing, a valve timing, and an exhaust gas recirculation amount so that the combustion state is improved when the deterioration of the combustion state is detected by the state determining means, and
the air-fuel ratio control means adjusts at least one of an ignition timing, a valve timing, and an exhaust gas recirculation amount to be close to an appropriate value around the lean-burn limit.

7. A combustion state determining apparatus according to claim 5, wherein the state determining means determines whether the combustion state is deteriorated with respect to each cylinder, and
the air-fuel ratio control means corrects the fuel injection amount with respect to each cylinder based on a determination result determined by the state determining means.

8. A combustion state determining apparatus for an internal combustion engine, comprising:
a peak position detecting means for detecting a heat generation peak position in which a generating heat amount every crank angle is maximum in a combustion period from a start of combustion to a termination of combustion; and
a state determining means for determining a combustion state of the internal combustion engine based on the heat generation peak position detected by the peak position detecting means.

9. A combustion state determining apparatus according to claim 8, wherein the state determining means determines the combustion state by comparing a subject heat generation peak position with an average of the heat generation peak positions which have detected in a predetermined period.

10. A combustion state determining apparatus according to claim 9, wherein the state determining means determines that the combustion state is deteriorated when a frequency in which a deviation between the subject heat generation peak position and the average of the heat generation peak position exceeds a predetermined value is larger than a predetermined threshold.

11. A combustion state determining apparatus according to claim 8, further comprising:
an air-fuel ratio control means for performing a lean-limit control in which an air-fuel ratio of air-fuel mixture to be supplied to the internal combustion engine is brought to a vicinity of a lean-combustion limit,
wherein the air-fuel ratio control means corrects a fuel injection amount to be increased in a case where a deterioration of the combustion state is detected, and corrects the fuel injection amount to be decreased in a case where the deterioration of the combustion state is not detected.

12. A combustion state determining apparatus according to claim 11, wherein the air-fuel ratio control means adjusts at least one of an ignition timing, a valve timing, and an exhaust gas recirculation amount so that the combustion state is improved when the deterioration of the combustion state is detected by the state determining means, and
the air-fuel ratio control means adjusts at least one of an ignition timing, a valve timing, and an exhaust gas recirculation amount to be close to an appropriate value around the lean-burn limit.

13. A combustion state determining apparatus according to claim 11, wherein the state determining means determines whether the combustion state is deteriorated with respect to each cylinder, and
the air-fuel ratio control means corrects the fuel injection amount with respect to each cylinder based on a determination result determined by the state determining means.

14. A combustion state determining apparatus for an internal combustion engine, comprising:
a first detecting means for detecting one of a heat generation center of gross heating amount and a heat generation peak position in which a generating heat amount every crank angle is maximum in a combustion period from a start of combustion to a termination of combustion;
a second detecting means for detecting an in-cylinder pressure peak position in which an in-cylinder pressure is maximum in the combustion period; and
a state determining means for determining a combustion state of the internal combustion engine based on one of the heat generation center and the heat generation peak position detected by the first detecting means and the in-cylinder peak position detected by the second detecting means.

15. A combustion state determining apparatus according to claim 14, wherein
the first detecting means detects the heat generation peak position, and
the state determining means determines that the combustion state is deteriorated when a frequency in which the in-cylinder pressure peak position appears earlier than the heat generation peak position exceeds a predetermined threshold.

16. A combustion state determining apparatus according to claim 14, further comprising:
an air-fuel ratio control means for performing a lean-limit control in which an air-fuel ratio of air-fuel mixture to be supplied to the internal combustion engine is brought to a vicinity of a lean-combustion limit,
wherein the air-fuel ratio control means corrects a fuel injection amount to be increased in a case where a deterioration of the combustion state is detected, and corrects the fuel injection amount to be decreased in a case where the deterioration of the combustion state is not detected.

17. A combustion state determining apparatus according to claim 16, wherein the air-fuel ratio control means adjusts at least one of an ignition timing, a valve timing, and an exhaust gas recirculation amount so that the combustion state is improved when the deterioration of the combustion state is detected by the state determining means, and
the air-fuel ratio control means adjusts at least one of an ignition timing, a valve timing, and an exhaust gas recirculation amount to be close to an appropriate value around the lean-burn limit.

18. A combustion state determining apparatus according to claim 17, wherein the state determining means determines whether the combustion state is deteriorated with respect to each cylinder, and
the air-fuel ratio control means corrects the fuel injection amount with respect to each cylinder based on a determination result determined by the state determining means.

19. A combustion state determining method for an internal combustion engine, comprising:
detecting a heat generation center of gross heating amount in a combustion period from a start of combustion to a termination of combustion; and
determining a combustion state of the internal combustion engine based on the heat generation center.

20. A combustion state determining method for an internal combustion engine, comprising:
detecting a heat generation peak position in which a generating heat amount every crank angle is maximum in a combustion period from a start of combustion to a termination of combustion; and
determining a combustion state of the internal combustion engine based on the heat generation peak position.

21. A combustion state determining method for an internal combustion engine, comprising:
detecting one of a heat generation center of gross heating amount and a heat generation peak position in which a generating heat amount every crank angle is maximum in a combustion period from a start of combustion to a termination of combustion;
detecting an in-cylinder pressure peak position in which an in-cylinder pressure is maximum in the combustion period; and
determining a combustion state of the internal combustion engine based on one of the heat generation center and the heat generation peak position and the in-cylinder peak position.
